(19) United States
(12) Patent Application Publication
(10) Pub. No.: US 2015/0183261 A1
(43) Pub. Date: Jul. 2, 2015

(54) HAND-HELD APPARATUS HAVING AT LEAST ONE ACTIVE ELEMENT SECURED WITH AT LEAST ONE MULTI-STEP SELF-CONTAINED CHILD SAFETY FEATURE

(71) Applicant: Christopher Rosica, Paramus, NJ (US)

(72) Inventor: Christopher Rosica, Paramus, NJ (US)

(21) Appl. No.: 14/644,360

(22) Filed: Mar. 11, 2015

Related U.S. Application Data
(63) Continuation of application No. 13/033,782, filed on Feb. 24, 2011, now abandoned.
(60) Provisional application No. 61/307,471, filed on Feb. 24, 2010.

(51) Int. Cl. B43K 29/00; B26B 29/00; B25B 15/00

(52) U.S. Cl. CPC B43K 29/00; B25B 15/00; B26B 29/00

(57) ABSTRACT

In various novel embodiments thereof, the inventive hand held active element instrument (such as a writing instrument (e.g., a pen, pencil, or marker) is readily operable by a qualified user, to be secured in such a manner as to minimize any risk of harm therefrom to a child who gains possession thereof and subjects the instrument to undesirable and/or dangerous physical manipulation, by preferably providing at least one self-contained securing component requiring two or more steps to secure and unsecure, that must be operated through the applicable number of provided steps, by the qualified user, in order to secure (and unsecure) the instrument's at least one active element. Advantageously the at least one multi-step self-contained securing component of the present invention, obviates any need to conceal the inventive hand held active element instrument, or to otherwise physically secure the location thereof when not in use, thereby eliminating the inconvenience of having to take such measures (that are necessary with currently available hand held active element instruments).

### CROSS REFERENCE TO RELATED APPLICATIONS

The present patent application claims priority from the commonly assigned co-pending U.S. patent application Ser. No. 13/033,782 entitled “Hand-held Apparatus Having at Least One Active Element Secured with at Least One Child Safety Feature”, filed Feb. 24, 2011, which in turn claims priority from the U.S. provisional patent application 61/307,471 entitled “Hand-held Apparatus Having at Least. One Active Element Secured with at Least One Child Safety Feature”, filed Feb. 24, 2010.

### FIELD OF THE INVENTION

The present invention relates generally to hand-held instruments and devices having at least one active element, and more particularly to a hand-held apparatus, instrument or tool, with at least one active element (such as a writing tip, injector, screwdriver tip, blade etc.), that, may be potentially harmful to a child, and that it supplied with at least one child safety feature that is operable to secure the at least one active element.

### BACKGROUND OF THE INVENTION

Many small hand-held instruments, tools, and similar devices in common use in typical households often comprise at least one active element (such as a writing tip on a pen, marker or pencil, an injector, a screwdriver tip, a blade, a substance dispenser, etc.), that may be potentially very harmful to a child who manages to somehow gain possession of such an apparatus (hereinafter individually and collectively referred to as a “Hand Held Active Element (HHAE) instrument”).

While some HHAE instruments comprise very basic components for covering up an active element thereof (such as a cap for a pen or for a craft knife), in many cases such “safety/cover components” may actually pose very significant risks to children in themselves. For example, most caps are relatively easy to pull from pens or substance dispensers (even for an average child), in which case in addition to the danger of the now exposed sharp pen tip, the child in possession of an attractive small object (i.e., the cap), which many studies have shown pose very significant chocking hazards.

Another common technique that is sometimes presented as an ostensible “safety measure”, is a retracting mechanism for the HHAE instrument's active element, such as a push-button/release element at one end of the instrument or a twist/lateral mechanism that advances/retracts the active element from/into the HHAE instrument housing, in response to one of the sections of the instrument housing being axially twisted with respect to the other section. While this approach does not create additional risks for a child, the relatively easy manner in which such mechanisms are operated, make it quite likely that a child playing with such an HHAE instrument would inadvertently activate the mechanism, thus moving the dangerous active element into a position in which it is capable of causing harm to a child. Referring now to FIGS. 4A to 4C, various such previously known and attempted techniques are illustrated.

The above-described problems can be even further exacerbated in connection with certain HHAE instruments that comprise more than one active element (and which therefore pose even a greater risk of harm to children).

At the same time, modifying instrument caps, push-buttons, release elements, and/or twist/lateral mechanisms to make them too difficult for children to operate, create significant ergonomic challenges for the target users of such instruments, many of whom would be very frustrated if they had to expend a significant effort every time they needed to unsecure a HHAE instrument for use, and the re-secure it thereafter.

As a result, typically, the only way a user can compensate somewhat for the above-noted flawed “safety features”, is to take a further step of concealing or otherwise secreting away the HHAE instrument away from the reach of children (or other incompetent “at-risk” parties), as an additional safety measure. Unfortunately, this additional step greatly reduces the user's ability to quickly access their HHAE instrument (which now must be retrieved from its secure location prior to use), makes the HHAE instrument significantly less convenient to use as it is no longer “at hand”, which is one of the key goals of its portability, and further increases the possibility that the user may lose or otherwise misplace it.

Therefore, it would thus be desirable to provide a HHAE instrument having at least one active element that is readily operable for being secured in such a manner as to minimize any risk of harm therefrom to a child who gains possession thereof, and subjects the instrument to physical manipulation. It would also be desirable to provide an apparatus a HHAE instrument having at least one active element, that is readily and easily securable by a qualified user thereof, during non-use, and that is readily and quickly un-securable by the qualified user in preparation for utilization thereof utilizing only the features/elements contained in the HHAE instrument itself. It would additionally be desirable to provide a HHAE instrument having at least one active element, that comprises at least one completely self-contained safety feature operable, without need for steps other than the operation thereof, to protect unqualified users thereof from undesirable contact with one or more of the active elements thereof, that is easy to operate, that enables the HHAE instrument to be left in the open for easy access and utilization thereof, and that may be inexpensively and readily fabricated.

### BRIEF DESCRIPTION OF THE DRAWINGS

In the drawings, wherein like reference characters denote corresponding or similar elements throughout the various figures:

FIG. 1A is an exemplary schematic side-view diagram illustrating a first exemplary embodiment of the inventive HHAE instrument having at least one active element, that is readily operable for being secured in such a manner as to minimize any risk of harm therefrom to a child or another unqualified user, who gains possession thereof;

FIG. 1B is an exemplary schematic side-view diagram illustrating an alternate embodiment of the inventive HHAE instrument of FIG. 1A, having at least one active element, that is readily operable for being secured in such a manner as to minimize any risk of harm therefrom to a child or another unqualified user, who gains possession thereof;

FIG. 1C is an exemplary schematic side-view diagram illustrating a second exemplary embodiment of the inventive HHAE instrument having at least one active element (also comprising at least one external component), that is readily operable for being secured in such a manner as to minimize any risk of harm therefrom to a child or another unqualified user, who gains possession thereof;

FIG. 1D is an exemplary schematic side-view diagram illustrating a third exemplary embodiment of the inventive HHAE instrument, that comprises a plurality of active elements, that is readily operable for securing the plural active elements in such a manner as to minimize any risk of harm therefrom to a child or another unqualified user, who gains possession thereof;

FIG. 1E is an exemplary schematic side-view diagram illustrating a fourth exemplary embodiment of the inventive HHAE instrument, that comprises a plurality of active elements, that is readily operable for securing the plural active elements in such a manner as to minimize any risk of harm therefrom to a child or another unqualified user, who gains possession thereof;

FIG. 2A is an exemplary schematic side-view diagram illustrating a first exemplary embodiment of an inventive self-contained multi-step securing/safety component, at least one of which may be readily utilized in one or more of the embodiments of the inventive HHAE instrument of FIGS. 1A to 1E, above;

FIG. 2B is an exemplary schematic side-view diagram illustrating a second exemplary embodiment of an inventive self-contained multi-step securing/safety component, at least one of which may be readily utilized in one or more of the embodiments of the inventive HHAE instrument of FIGS. 1A to 1E, above;

FIG. 2C is an exemplary schematic side-view diagram illustrating a third exemplary embodiment of an inventive self-contained multi-step securing/safety component, at least one of which may be readily utilized in one or more of the embodiments of the inventive HHAE instrument of FIGS. 1A to 1E, above;

FIGS. 3A to 3D illustrate various alternate exemplary embodiments of the inventive HHAE instrument being implemented as a writing instrument; and

FIGS. 4A to 4C illustrate attempted (and largely unsuccessful) prior art solutions for securing previously known HHAE instruments.

### SUMMARY OF THE INVENTION

The present invention is directed to a novel hand held active element (“HHAE”) instrument having at least one active element that may be utilized in a manner that is potentially harmful to certain users, and that comprises at least one selectively operable fully self-contained safety feature that minimizes the risk of harm to the certain “unqualified” users from the at least one potentially harmful at least one active element. In summary, the novel HHAE instrument comprises at least one safety feature to protect unqualified users thereof from undesirable contact with one or more of the active elements thereof, that is easy to operate, and that may be inexpensively and readily fabricated.

In various exemplary embodiments thereof, the inventive HHAE instrument comprises at least one active element that is readily operable for being secured in such a manner as to minimize any risk of harm therefrom to a child (or other similarly incompetent user (e.g., a diminished mental capacity adolescent or adult)) who gains possession thereof, and subjects the instrument to physical manipulation. Advantageously, in its various exemplary embodiments, the at least one active element of the inventive HHAE instrument is readily and easily securable by a qualified user thereof, during non-use, and is readily and quickly un-securable by the qualified user in preparation for utilization thereof, without having to conceal or otherwise secret it away.

This may be accomplished, in accordance with the present invention, by preferably providing at least one self-contained securing component requiring two or more steps to secure and unsecure, that must be operated through the applicable number of provided steps, by the qualified user, in order to secure and unsecure the instrument's at least one active element.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF PREFERRED EMBODIMENTS

In various novel embodiments thereof, the inventive HHAE instrument is readily operable by a qualified user, to be secured in such a manner as to minimize any risk of harm therefrom to a child who gains possession thereof, and subjects the instrument to physical manipulation, by preferably providing at least one self-contained multi-step securing component, that must be operated through the applicable number of provided steps, by a qualified user order to secure and unsecure the instrument's at least one active element. The inventive HHAE instrument includes at least one active element that is readily and easily securable by a qualified user thereof, during non-use, and that is readily and quickly un-securable by the qualified user in preparation for utilization thereof. Advantageously, the inventive HHAE instrument is easy to operate, and may be inexpensively and readily fabricated.

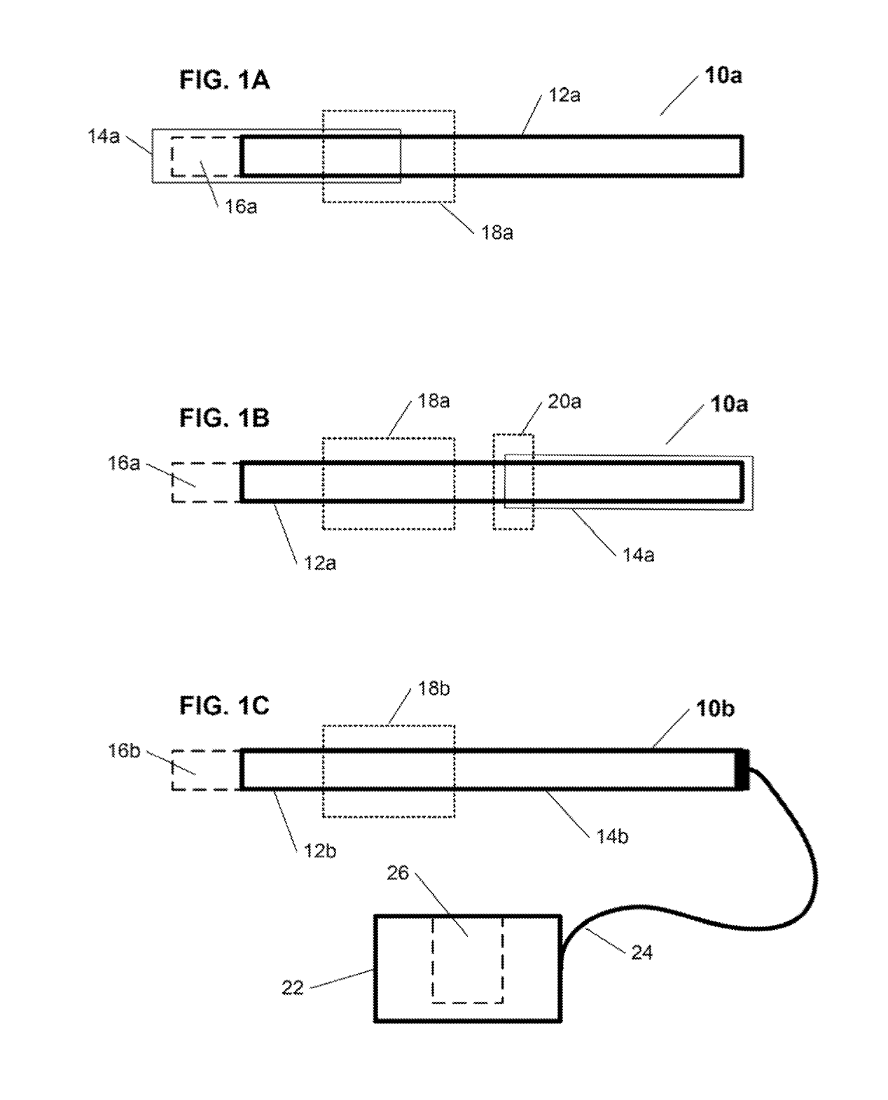

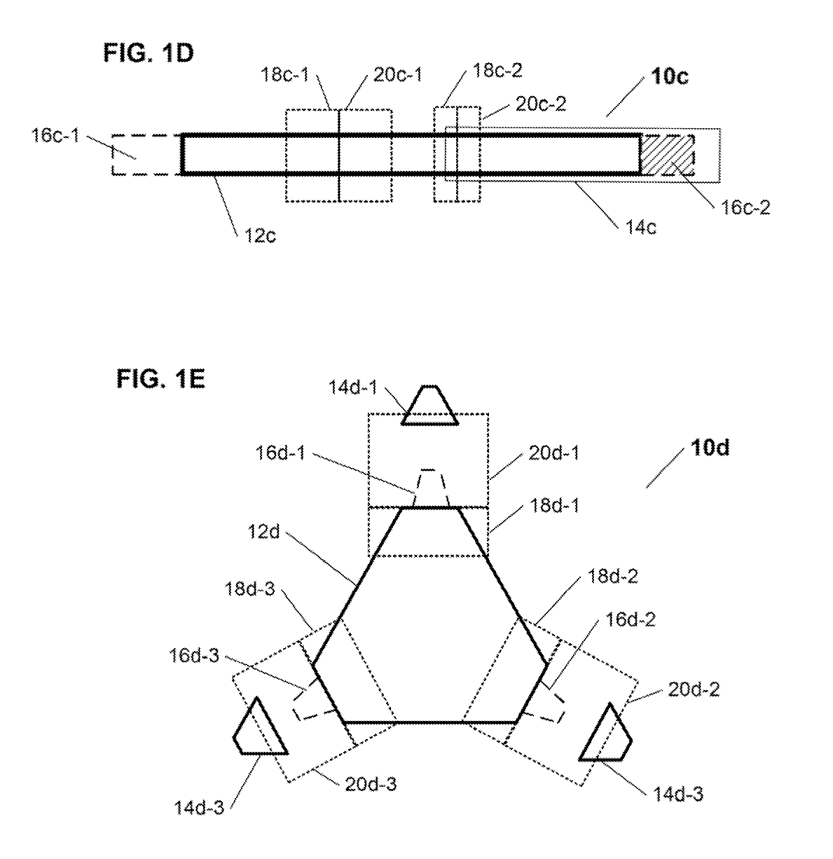

At the outset, it should be noted that in the various drawing FIGS. 1A-3D, and in accompanying descriptions herein various inventive apparatus shapes, sizes, as well as the shapes, sizes and designs of various inventive apparatus elements, components and features, that may be provided in accordance with the present invention, are shown by way of example only, and subjects to specific descriptions herein, shall not serve as a limitation on the type, size or configuration of shapes, elements, components and features that are protected or protectable by the patent claims presented herewith.

Furthermore, it is readily contemplated that various embodiments of the inventive apparatus of FIGS. 1A-3D, may be produced from virtually any material, or combination of materials, suitable for use in small hand-held instruments with one or more active elements. Such materials, capable of being utilized in production of the inventive apparatus may include, but are not limited to, one or more of the following: plastic (and other materials from the plastic family), polymers, metal, wood, resilient materials (foam, porous resilient substances, vulcanized rubber, etc.), and/or other equivalent natural or synthetic materials, that may be selected as a matter of design choice, convenience, or necessity, without departing from the spirit of the present invention. Advantageously, the above-described materials, or combinations thereof, may be utilized in a wide variety of textures, thicknesses, colors, transparencies, and/or other properties or configurations, as a matter of design choice, convenience, or necessity, without departing from the spirit of the present invention.

Referring now to FIG. 1A, an exemplary schematic side-view diagram illustrates a first exemplary embodiment of an inventive HHAE instrument 10a having at least one active element 16a and that is readily operable for being secured in such a manner by at least one self-contained multi-step securing component 18a, so as to minimize any risk of harm therefrom to a child or another unqualified user, who gains possession thereof.

Referring now to FIG. 1B, an exemplary schematic side-view diagram illustrates an alternate exemplary embodiment of the inventive HHAE instrument 10a of FIG. 1A, having at least one active element 16a, and that is readily operable for being secured in such a manner by at Feast one additional self-contained securing component 20a, that provides at least one additional step to the steps made necessary by the self-contained securing component 18a.

Referring now to FIG. 1C, an exemplary schematic side-view diagram illustrates a second exemplary embodiment of the inventive HHAE instrument 10b having at least one active element 16b (also comprising at least one external elf-contained component 22), that is readily operable for being secured in such a manner as to minimize any risk of harm therefrom to a child or another unqualified user, who gains possession thereof;

Referring now to FIG. 1D, an exemplary schematic side-view diagram illustrates a third exemplary embodiment of the inventive HHAE instrument 10c, that comprises a plurality of active elements (16c-1, 16c-2). that is readily operable for securing, via plural self-contained securing components (18c-1 18c-2, 20c-1, 20c-2), the plural active elements (16c-1, 16c-2), in such a manner as to minimize any risk of harm therefrom to a child or another unqualified user, who gains possession thereof;

Referring now to FIG. 1E, an exemplary schematic side-view diagram illustrates a fourth exemplary embodiment of the inventive HHAE instrument 10d, that comprises a plurality of active elements 16d-1 to 16d-3, that is readily operable for securing the plural active elements, via plural self-contained securing components 20d-1 to 20d-3, and in such a manner as to minimize any risk of harm therefrom to a child or another unqualified user, who gains possession thereof.

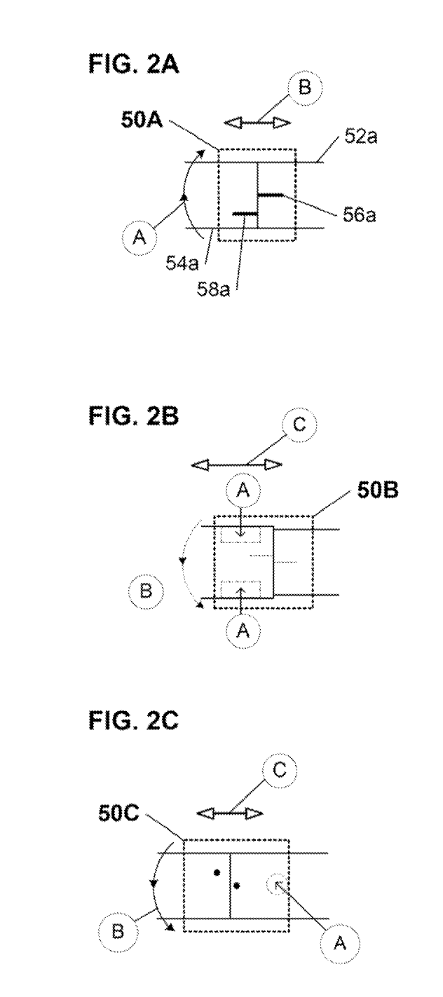

Referring now to FIG. 2A, an exemplary schematic side-view diagram illustrates a first exemplary embodiment of an inventive self-contained multi-step securing/safety component 50A, at least one of which may be readily utilized in one or more of the embodiments of the inventive HHAE instrument 10a to 10d of the FIGS. 1A to 1E, above.

Referring now o FIG. 2B, an exemplary schematic side-view diagram illustrates a first exemplary embodiment of an inventive self-contained multi-step securing/safety component 50B at least one of which may be readily utilized in one or more of the embodiments of the inventive HHAE instrument 10a to 10d of the FIGS. 1A to 1E, above.

Referring now to FIG. 2C, an exemplary schematic side-view diagram illustrates a first exemplary embodiment of an inventive self-contained multi-step securing/safety component 50C, at least one of which may be readily utilized in one or more of the embodiments of the inventive HHAE instrument 10a to 10d of the FIGS. 1A to 1E, above.

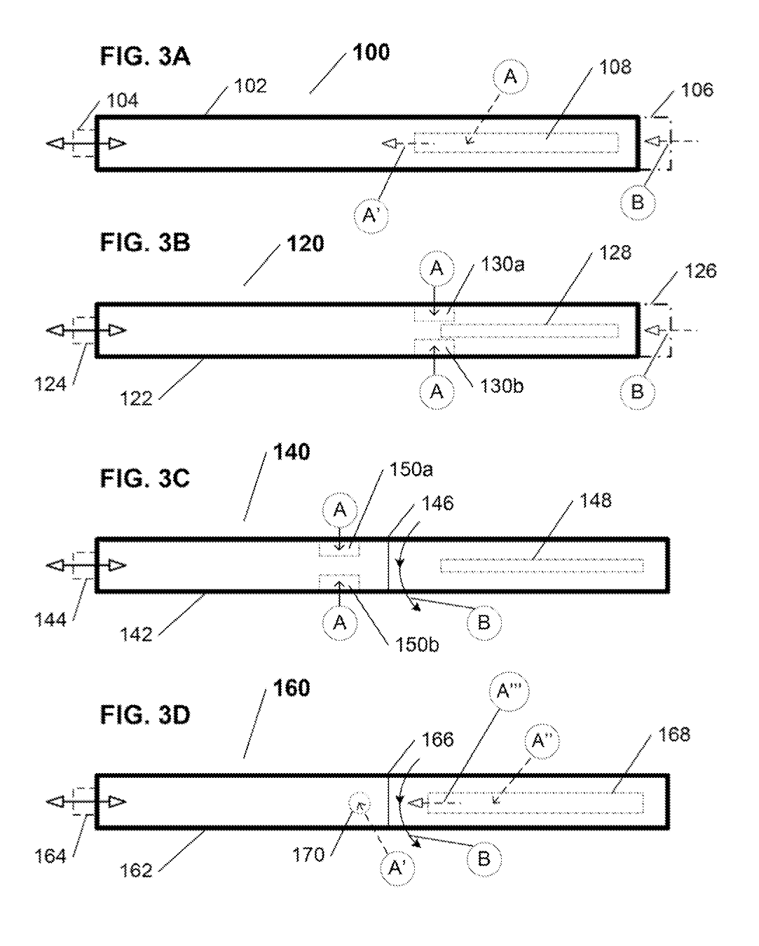

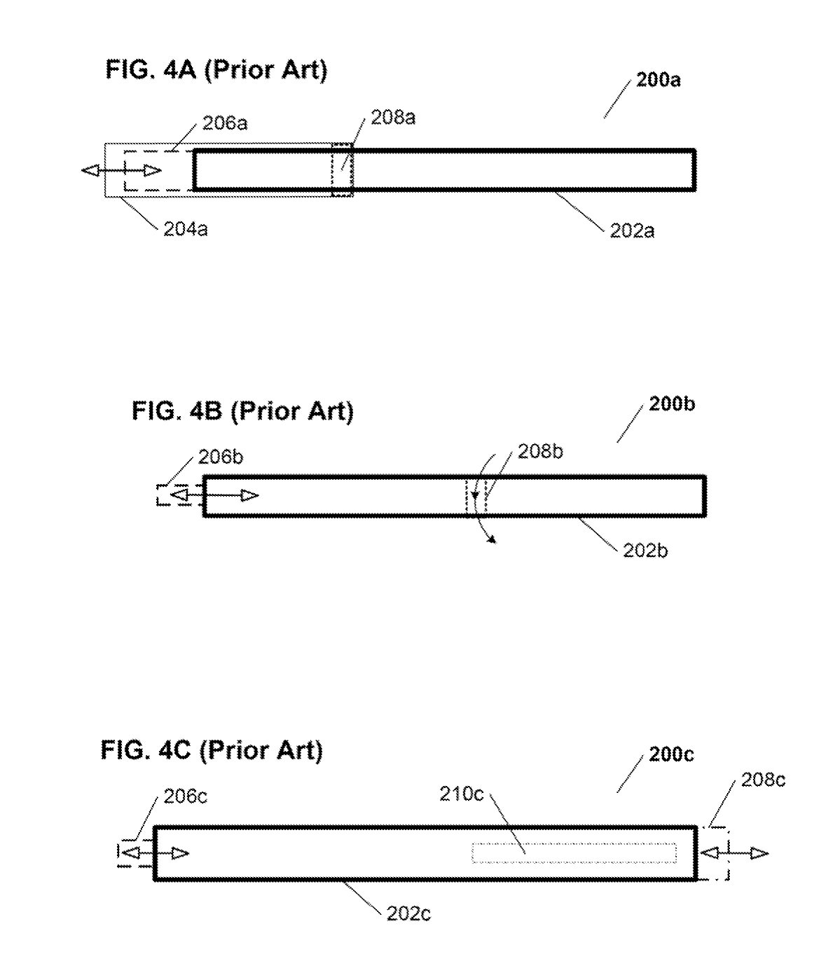

Referring now to FIGS. 3A to 3D, various alternate exemplary embodiments of the inventive HHAE instrument being implemented as a writing instrument, are each illustrated as a securable writing instrument 100, 120, 140, and 160, in respective FIGS. 3A to 3D. Each novel securable writing instrument 100. 120, 140, and 160 preferably utilizes one or more of the novel components and techniques described above in connection with FIGS. 1A to 1E and in FIGS. 2A to 2C.

Thus, while there have been shown and described and pointed out fundamental novel features of the inventive system and method as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

I claim:

1. A hand-held apparatus comprising at least one active element, each operable by a qualified user to perform at least one predetermined desired task, that comprises:
at least one self-contained multi-step securing component that is selectively operable by the qualified user through at least two separate steps, to be configured in a “secure mode” that minimizes any risk of harm therefrom to an unqualified user who gains possession thereof and subjects the instrument to physical manipulation, and
further operable by the qualified user to be configured in a “utilization mode” during which, the at least one active element may be readily utilized by the qualified user in performance of the at least one predetermined task.
